(19) United States
(12) Patent Application Publication
(10) Pub. No.: US 2025/0384415 A1
(43) Pub. Date: Dec. 18, 2025

(54) SYSTEMS AND METHODS FOR ENHANCED NETWORK INTERACTIONS

(71) Applicant: MASTERCARD INTERNATIONAL INCORPORATED, PURCHASE, NY (US)

(72) Inventors: Nishith Shah, Ardsley, NY (US); Christopher Loh, New York, NY (US); Gerardo Cardone, Staten Island, NY (US); Sherri Gayle Haymond, Westport, CT (US); Vimal Kanagaraj Veluthai, New York, NY (US)

(21) Appl. No.: 19/228,338

(22) Filed: Jun. 4, 2025

Related U.S. Application Data
(60) Provisional application No. 63/659,649, filed on Jun. 13, 2024.
(60) Provisional application No. 63/673,044, filed on Jul. 18, 2024.
(60) Provisional application No. 63/709,820, filed on Oct. 21, 2024.

(51) Int. Cl. G06Q 20/10; G06Q 20/32; G06Q 20/38; G06Q 40/04

(52) U.S. Cl. CPC G06Q 20/108; G06Q 20/3223; G06Q 20/3278; G06Q 20/381; G06Q 40/04

(57) ABSTRACT

Systems and methods are provided for use in enhanced network transactions. One example method includes receiving, by a processing network, a request for a fund transfer from a mobile device, in lieu of a request from a financial institution, the fund transfer between a source account and a destination account, the mobile device associated with one of a sender user and a receiver user, the request including an amount of the fund transfer and a credential associated with the destination account; identifying, by the processing network, an acquiring credential of a financial institution that issued the source account; transmitting, by the processing network, an authorization request for the fund transfer to the financial institution, whereby the financial institution approves the fund transfer; and based on the approval from the financial institution, initiating the fund transfer between the source account and the destination account.

### CROSS-REFERENCE TO RELATED APPLICATIONS

This application claims the benefit of, and priority to, U.S. Patent Application No. 63/659,649, filed on Jun. 13, 2024, U.S. Patent Application No. 63/673,044, filed on Jul. 18, 2024, and U.S. Patent Application No. 63/709,820, filed on Oct. 21, 2024. The entire disclosure of each of the above applications is incorporated herein by reference.

### FIELD

The present disclosure generally relates to systems and methods for use in enhanced network interactions.

### BACKGROUND

This section provides background information related to the present disclosure which is not necessarily prior art.

Parties are known to transfer resources through network interactions (e.g., through digital payments, etc.). In one example, the network interactions may involve different accounts, whereby users associated with the accounts purchase products or services from merchants and/or service providers and fund the purchases through the accounts. Also, it is known for users to transfer funds to other users through person-to-person, or P2P, transactions, and which again involve accounts. The P2P transactions are available through mobile applications, including, for example, the PAYPAL and VENMO applications. Apart from such digital payments or transfers, users are also still known to provide checks or cash payments to merchants and/or service providers in exchange for products or services.

### DRAWINGS

The drawings described herein are for illustrative purposes only of selected embodiments and not all possible implementations, and are not intended to limit the scope of the present disclosure.

FIG. 1 is an example system of the present disclosure suitable for use in enhanced network transactions;

FIG. 2 is a block diagram of an example computing device that may be used in the system of FIG. 1;

FIG. 3 is an example method that may be implemented in the system of FIG. 1 for use in facilitating an enhanced network transactions (e.g., a transfer, etc.) between a sender user and a receiver user; and

FIG. 4 is an example method that may be implemented in the system of FIG. 1 for use in facilitating enhanced cross-border network transactions (e.g., a cross-border network transfer, etc.) between a sender user and a receiver user; and

FIG. 5 is an example method that may be implemented in the system of FIG. 1 for use in facilitating contactless initiated network transactions between a sender user and a receiver user.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Transactions between different accounts may be limited due to: cumbersome processes for identification of the accounts, required access to mobile devices (e.g., smartphones, etc.), interactions with associated banks, user authentications, etc., which are generally in place for the protection of the users and/or based on regulations imposed on such transactions. What's more, in person-to-person (P2P) transactions through a mobile application, the publisher of the application is required to be certified and/or validated into the payment eco-system, which is generally a cumbersome process, especially for non-bank parties. As such, in situations where a user decides to use VENMO services, for example, or generally, a fund transfer service through a user interface (UX), the host of the UX, despite its limited role in the transaction, is still required to be certified and/or validated into the payment eco-system. Also, in P2P transactions, the sharing of account numbers, or proxies, may be problematic, insecure, etc., depending on the person involved in the transactions.

Uniquely, the systems and methods herein may provide for enhanced network transactions, between accounts, where communication from a mobile application is directed to a processing network, where the appropriate credentials are resolved, in lieu of communication through one or more financial institutions. In this way, application publishers for applications associated with the transfer may be alleviated of cumbersome processes associated with certifications and/or validations, etc. Further, uniquely, the systems and methods herein may provide for contactless network transactions, between accounts, where transfer-specific credentials (e.g., push only credentials, pull only credentials, etc.) are shared, through contactless interactions with card devices, between senders and receivers, from which the transfers are initiated. In this manner, P2P transfers are extended to contactless interactions, with limited additional participation by ones of the senders and receivers.

In this manner, the systems and methods herein provide for one or more technical solutions, in the context of fund transfers, where the technical problems arise from the advent of technologies to the field.

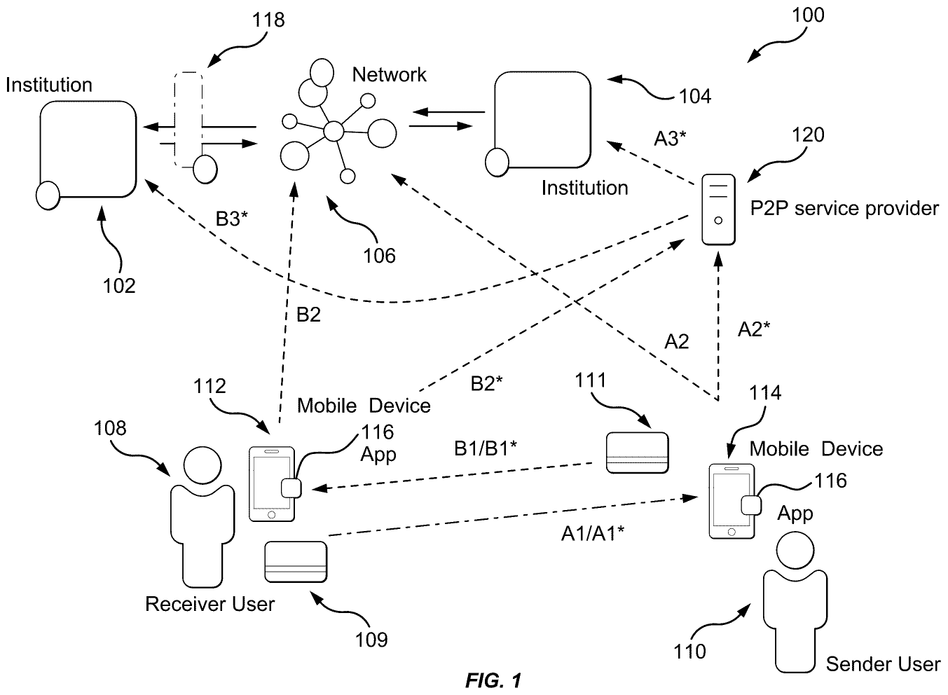

FIG. 1 illustrates an example system 100, in which one or more aspects of the present disclosure may be implemented. Although the system 100 is presented in one arrangement in FIG. 1, other embodiments may include systems arranged otherwise depending, for example, on a manner in which account transfers are initiated, arrangement with processing networks and/or financial institutions, types of credentials, manners of contactless communications, privacy rules and regulations, etc.

In the illustrated embodiment, the system 100 generally includes financial institutions 102 and 104 and a processing network 106, each coupled to (and in communication with) one or more networks. The one or more networks are represented in FIG. 1 by the various arrowed, solid or (potentially) dotted lines and each may include, without limitation, a local area network (LAN), a wide area network (WAN) (e.g., the Internet, etc.), a mobile network, and/or another suitable public and/or private network capable of supporting communication among two or more of the parts illustrated in FIG. 1, or any combination thereof. For example, one of the networks may include multiple different networks, such as a private payment transaction network made accessible by the processing network 106 to the financial institutions 102 and 104 and, separately, the public Internet, which is accessible as desired by the processing network 106 and one or more devices associated with users in the system 100, etc.

The financial institution 102 in the system 100 is configured to issue one or more accounts (e.g., payment accounts, etc.). In this example, the financial institution 102 is associated with a user 108 (i.e., a receiver user) and has issued an account for receiver user 108, where the account is a payment account. The account is linked to a card device 109 (e.g., a credit card, debit card, etc.), which is enabled, in this embodiment, for contactless communication. That is, the card device 109, in this example embodiment, is enabled for near field communication (NFC). It should be appreciated that the card device 109 may be configured for other contactless communication schemes in other embodiments. Similarly, the financial institution 104 is configured to issue one or more accounts (e.g., payment accounts, etc.). And, in this example, the financial institution 104 is associated with a user 110 (i.e., a sender user) and has issued a payment account for the sender user 110. The account is linked to a card device 111, which is generally consistent with the card device 109.

The accounts may include, without limitation, credit accounts, debit accounts, prepaid accounts, crypto accounts, savings accounts, etc. With that said, in various embodiments, both of the financial institutions 102 and 104 may be other entities (e.g., financial or otherwise, etc.) associated with the users 108 and 110 in other system embodiments.

Each of the financial institutions 102 and 104 is coupled to and/or is in communication with the processing network 106 (via one or more networks), whereby the processing network 106 is configured to facilitate transactions (broadly, network transactions) between different accounts issued by the financial institutions 102 and 104 (and other financial institutions). In particular, the processing network 106 is configured to facilitate authorization of the transactions and also clearing and settlement of the transactions between the accounts involved therein. The authorization, clearing and settlement may be over a period of hours, or days, or may be in a real time (or near real time), etc. As such, the processing network 106 may include, for example, without limitation, the MASTERCARD, VISA or AMEX, processing network, etc.

Further, the users 108 and 110 in the system 100 are associated with mobile devices 112 and 114, respectively. The mobiles device 112 and 114 may each include portable communication devices, such as, for example, smartphones, tablets, laptops, etc., configured to communicate with parts of the system 100, as described herein, via one or more networks as indicated by the solid and dotted lines. And, in the illustrated embodiment, the mobile devices 112 and 114 each include a mobile application 116. Then, for each of the mobile devices 112 and 114, the mobile application 116 includes executable instructions, stored in a non-transitory storage medium within the given mobile devices 112 and 114, which cause the mobile devices 112 and 114 to perform the various operations described herein.

In this example embodiment, the mobile application 116 is specific to and/or published by a virtual wallet platform, or potentially, one of the financial institutions 102, 104, illustrated in FIG. 1. Uniquely, as illustrated in FIG. 1, the mobile application 116 configures the mobile devices 112, 114 to communication directly with the processing network 106. That said, the mobile devices 112, 114 may be configured to communicate with the processing network 106 through a backend for the mobile application (not shown), but which is not part of either of the financial institution 102, 104. Stated another way, the mobile application 116 configures the respective mobile device 112, 114 to interface with processing network 106 for at least two purposes: (a) to register and look up user/account credentials in a directory (e.g., click-to-pay directory, etc.) within a database of the processing network 106, and (b) to initiate funding and payment transaction requests via send services within the processing network 106. In this role, the mobile application 116 configures the respective mobile device to act as a transaction initiator. In this exemplary embodiment, the processing network 106, in response, is configured to interact with the institution 102 or the institution 104, via the acquiring credential of the same (based on the account credential provided in the request) to process the funding and payment transactions, which, then, serves to maintain the mobile devices 112, 114, the mobile application 116, and any backend of the mobile application 116 completely outside the flow of funds (e.g., outside of the conventional payment rails, etc.). This should be understood to be direct communication in the context of the description of this example embodiment herein.

In this example embodiment, the mobile application 116 is installed in each of the mobile devices 112 and 114 and is provisioned with an account credential associated with the account issued to the respective one of the users 108 and 110 with which the mobile devices 112 and 114 are associated. Specifically, the mobile application 116 in the mobile device 112 is provided with the account credential for the account issued, by the financial institution 102, to the receiver user 108. Likewise, the mobile application 116 in the mobile device 114 is provided with the account credential for the account issued, by the financial institution 104, to the sender user 110. In both cases, the payment account credentials may include, for example, a token/proxy, a primary account number (PAN), etc., and may further be specific to a type of transaction (e.g., push only, pull only, etc., transactions credentials, etc.).

It should be appreciated that one or more additional accounts may be issued to one or both of the users 108, 110. In at least one example, the user 108 is issued an account from each of the institutions 102, 104, whereby funds may be transferred between accounts of the same user 108, through the operations herein.

What's more, the payment transfers (broadly, interactions or transactions) herein should not be understood to be limited to the mobile devices 112, 114, as other devices may be employed to initiate payment transfers. In such embodiments, the sender user 110 and/or the receiver user 108, for example, may access the payment transfer services through general computing devices or remote servers, which access a website, web application or web service, etc. embodying the functionality of the mobile application 116, whereby cloud-tokens, for example, may be leveraged in connection with payment transfers.

Further, in connection with payment transfers among different accounts, each of the financial institutions 102, 104 is enrolled with the processing network 106 for payment transfers, via the mobile application 116. That is, to enable the application 116 to initiate payment transfers, each account, or range of accounts, is enrolled with the processing network 106. As such, the processing network 106 is configured to enroll the financial institution 102, for example, whereby the processing network 106 is configured to store a mapping between one or more account credentials issued by the financial institution 102 and an acquiring credential for the financial institution 102. The processing network 106 is configured to store the mapping in a database, for use as described below. It should be appreciated, therefore, that the processing network 106 may be configured to interact with the financial institution 102 for a range of accounts, or individual accounts, or that the processing network 106 may be configured to interact with the receiver user 108, at the mobile device 112, via the mobile application 116, to enroll the specific account issued to the receiver user 108, whereby a mapping of the account credential of the receiver user's account and the acquiring credentials of the financial institution 102 is stored in the database. The same should be understood to be true for the financial institution 104 and the sender user 110.

In addition, as shown, the example system 100 further includes a P2P service provider 120, which is configured to initiate and/or facilitate P2P transfers between accounts. The P2P service provider 120 is configured to communicate with parts of the system 100, as described herein, via one or more networks as indicated by the solid and (potentially) dotted lines, etc.

Based on the above, in connection with a fund transfer from the sender user 110 to the receiver user 108, the transfer may be coordinated by either user.

In one example, where the sender user 110 coordinates the transfer, the sender user 110 accesses the mobile application 116, at the mobile device 114, and indicates an instruction to transfer funds from the sender user 110 to the receiver user 108. In response, the mobile device 114, as configured by the application 116, solicits the details of the account to which the funds are to be transferred, such as, for example, account credential (e.g. primary account number (PAN), token, etc.), recipient's name, etc., and then also and the amount of the transfer and potentially, a selection of an account to fund the transfer, and other suitable data. The sender user 110 provides the solicited information to the mobile device 114, through entry of the data to an input device of the same (e.g., via manual entry, etc.). Specific to the account credential for the destination account, in one or more embodiments, the mobile device 114, as configured by the application 116, may prompt the tap or insertion of a card device (or wallet device) of the receiver user 108 to acquire the account credential for the destination account. In such an embodiment, in response to the prompt, the receiver user 108 taps the card device 109 on, or otherwise contactlessly interacts with, or inserts the card device 109 into, the mobile device 114 of the sender user 110 (represented at dotted line A1), whereby the mobile device 114, as configured by the application 116, interacts (via a network communication) with the card device 109 such that the card device 109 is configured to transmit the account credential, and potentially other data, to the mobile device 114.

It should be appreciated that the mobile device 114, as configured by the application 116, may rely on the data from the card device 109, via the interaction, or use that data from the card device 109 to retrieve additional information about the destination account and/or the receiver user 108. For example, the mobile device 114, as configured by the application 116, interacts with the processing network 106 to receive a name, address, etc., for the receiver user 108, or an account credential specific to the destination account based on data from the card device 109.

Additionally, or alternatively, the mobile device 114, as configured by the application 116, may be configured to retrieve the account credential based on a proxy received from the sender user 110 or the receiver user 108. For example, the receiver user 108, instead of tapping/inserting the card device 109, may enter a phone number, email address or other proxy specific to the destination account and/or the receiver user 108 (e.g., name, address, etc.), whereby the mobile device 114, as configured by the application 116, looks up the proxy with the processing network 106, or another party (e.g., proxy directory computing device) (e.g., to resolve the proxy, etc.) to retrieve the account credential. In this way, the phone number, email address or other proxy may be included in a request for proxy resolution, in lieu of a payment account number. More generally, FIG. 1 includes a number of filled circles (e.g., dots, etc.) at various parts of the system 100, any of which part may be involved with the mobile device 114 or the processing network 106, in the resolution of the proxy (e.g., as the proxy directory computing device, etc.) into an account number or other account data, as appropriate to the specific flow of data.

Upon receipt of the appropriate data, it should be appreciated that in one or more embodiments, the mobile device 114, as configured by the application 116, may submit a request for name validation, or eligibility of one or both of the accounts for the specific fund transfer at this point, from the financial institution 102 and/or the financial institution 104, or potentially, the processing network 106, etc.

Thereafter, the mobile device 114, as configured by the application 116, submits a request for the fund transfer to the processing network 106 (represented at dotted line A2), where the request includes the account credential from the card device 109 (or phone number, email address, or other proxy specific to the destination account and/or the receiver user 108, if applicable) and an account credential for the source account (e.g., at the financial institution 104, etc.). The request also includes the amount of the transfer and any other data required for the transfer, and also any data elements required for a card-to-card, or P2P, transaction (as defined by the processing network 106, or service provided thereby).

Specifically, in this example embodiment, it should be appreciated that the mobile device 114, as configured by the application 116, submits the request, to the processing network 106, as an application programming interface (API) call to a Send Funding API exposed by the processing network 106. In connection therewith, the mobile device 114, as configured by the application 116, performs a look-up of the acquiring credential for the financial institution 104, via the processing network 106 (and corresponding database), based on the funding account credential included in the API call, as the funding institution for the fund transfer, and includes the acquiring credential in the request for the fund transfer.

In response, the processing network 106 is configured to compile and transmit an authorization request to the financial institution 104, where the request, in this embodiment, is consistent with the ISO 8583 (e.g., as a 0110 response, a 0210 response, etc.) (e.g., or potentially, the ISO 20022 standard, etc.). The authorization request includes the acquiring credential, account credentials for the account issued by the financial institution 104 to the sender user 110, name, address and account credential for the receiver user 108, and the amount of the transaction, among other data provided by the mobile device 114, etc. In turn, the financial institution 104 is configured to again provide sufficient information for purposes of transaction validation and/or verification (e.g., for one or more regulatory purposes (e.g., anti-money laundering regulations, etc.), etc.) and to compile a transaction reply, which, in this embodiment, is consistent with the ISO 8583 (e.g., as a 0110 response, a 0210 response, etc.) (e.g., or potentially, the ISO 20022 standard, etc.). The authorization reply indicates either approval or decline of the fund transfer. The financial institution 104 is configured to transmit the transaction reply back to the processing network 106, which is configured to pass the approval (or decline) to the mobile device 114.

Where the authorization reply indicates approval for the fund transfer, the mobile device 114, as configured by the application 116, submits the request, to the processing network 106, as an API call to a Send Payment API exposed by the processing network 106. In response, the processing network 106 is configured to initiate the fund transfer between the financial institution 102 and the financial institution 104, via a Send API. In connection therewith, the processing network 106 is configured to initiate a push leg of the fund transfer to the financial institution 104 (i.e., sender institution), via the acquiring credential, whereby the financial institution 104 is configured to process the request (e.g., for approval, regulatory compliance, etc.) and to submit the fund transfer to the financial institution 102 (i.e., receiver institution), via the processing network 106. The financial institution 102, in turn, is configured to conduct due diligence on the fund transfer and to approve or decline the fund transfer. Upon approval, the financial institution 102 is configured to post funds to the receiver user's account. The funds are then transferred from the financial institution 104 to the financial institution 102. The funds are transferred in near-real time.

In another example, where the receiver user 108 coordinates the transfer, the receiver user 108 accesses the mobile application 116 and indicates an instruction to transfer funds from the sender user 110 to the receiver user 108. In response, the mobile device 112, as configured by the application 116, solicits the details of the account to which the funds are to be transferred, such as, for example, an account credential, recipient's name, the amount of the transfer, and potentially, a selection of an account to fund the transfer, and other suitable data. The receiver user 108 provides the solicited information to the mobile device 112, through entry of the data to an input device of the same (e.g., by typing to an alpha-numeric pad, etc.). Specific to the account credential, in at least one embodiment, the mobile device 112, as configured by the application 116, may prompt the tap of a card device (or wallet device) of the sender user 110 to acquire the account credential. In such an embodiment, in response to the prompt, the sender user 110 taps the card device 111 on, or otherwise contactlessly interacts with, the mobile device 112 of the receiver user 108 (represented at dotted line B1), whereby the mobile device 112, as configured by the application 116, interacts with the card device 111 such that the card device 111 is configured to transmit the account credential, and potentially other data, to the mobile device 112.

It should be appreciated that the mobile device 112, as configured by the application 116, may rely on the data from the card device 111, via the interaction (e.g., contactless interaction, etc.), or use that data from the card device 111 to retrieve additional information about the source account and/or the sender user 110. For example, the mobile device 112, as configured by the application 116, may interact with the processing network 106 to receive a name, address, or account credential, etc., for the sender user 110 based on data from the card device 111.

Additionally, or alternatively, the mobile device 112, as configured by the application 116, may be configured to retrieve the account credential based on a proxy entered at the mobile device 112. For example, the sender user 110, instead of tapping/inserting the card device 111, may enter a phone number, email address or other proxy specific to the funding account and/or the sender user 110, whereby mobile device 112, as configured by the application 116, looks up the proxy with the processing network 106, or another party (e.g., proxy directory computing device, etc.) to retrieve the account credential. In this way, the phone number, email address or other proxy may be included in a request for proxy resolution. More generally, again, FIG. 1 includes a number of filled circles (e.g., dots, etc.) at various parts of the system 100, any of which parts may be involved with the mobile device 112 or the processing network 106, in the resolution of the proxy (e.g., as the proxy directory computing device, etc.) into an account number or other account data, as appropriate to the specific flow of data.

Upon receipt of the appropriate data, it should be appreciated that in one or more embodiments, the mobile device 112, as configured by the application 116, may submit a request for name validation, or eligibility of one or both of the accounts for the specific fund transfer at this point, from the financial institution 102 and/or the financial institution 104, or potentially, the processing network 106, etc.

Thereafter, the mobile device 112, as configured by the application 116, submits a request for the fund transfer to the processing network 106 (represented at dotted line B2), where the request includes the account credential from the card device 111 (or phone number, email address, or other proxy specific to the funding account and/or sender user 110, if applicable) and an account credential for the destination account (e.g., at the financial institution 102, etc.). The request also includes the amount of the transfer and any other data required for the transfer, and also any data elements required for a card-to-card, or P2P, transaction (as defined by the processing network 106, or service provided thereby).

Specifically, in this example embodiment, it should be appreciated that the mobile device 112, as configured by the application 116, submits the request, to the processing network 106, as an API call to the Send Funding API exposed by the processing network 106. In connection therewith, the mobile device 112, as configured by the application 116, performs a look-up of the acquiring credential of the financial institution 104, via the processing network 106 (and the corresponding database, etc.), as the funding institution for the fund transfer, and includes the acquiring credential in the request for the fund transfer.

In connection therewith, the processing network 106 is configured to compile and transmit an authorization request to the financial institution 104, where the request, in this embodiment, is consistent with the ISO 8583 (e.g., as a 0110 response, a 0210 response, etc.) (e.g., or potentially, the ISO 20022 standard, etc.). The authorization request includes the account credentials for the account issued by the financial institution 104 to the sender user 110 and the amount of the transaction, among other data, etc. In turn, the financial institution 104 is configured to compile a transaction reply, which, in this embodiment, is consistent with the ISO 8583 (e.g., as a 0110 response, a 0210 response, etc.) (e.g., or potentially, the ISO 20022 standard, etc.). The authorization reply indicates either approval or decline of the fund transfer. The financial institution 104 is configured to transmit the transaction reply back to the processing network 106, which is configured to pass the approval (or decline) to the mobile device 114.

Where the authorization reply indicates approval for the fund transfer, the mobile device 114, as configured by the application 116, submits the request, to the processing network 106, as an API call to a Send Payment API. In response, the processing network 106 is configured to initiate the payment transfer between the financial institution 102 and the financial institution 104, via a Send API, whereby the funds are transferred in near-real time. That is, consistent with the above description, the financial institution 102 is configured to post funds to the receiver user's account and the financial institution 104 is configured to debit funds to the sender user's account.

In yet another example, where the sender user 110 coordinates a fund transfer to an account in a different destination country (i.e., a cross-border fund transfer), the sender user 110 accesses the mobile application 116, at the mobile device 114, and indicates an instruction to transfer funds from the sender user 110 to the receiver user 108.

At the outset, it should be understood that each of the accounts involved in the transfer are registered with the respective applications 116, whereby specific information about the receiver user 108 and the sender user 110 is stored in the respective mobile devices 112, 114. That said, in this example, the processing network 106 is configured to interact with an intermediary financial institution 118 in the destination country, which, in turn, is configured for real-time transfers (RTPs), via a real-time transfer network (e.g., domestic instant transfer rails in the destination country, etc.) in that destination country. In this example, also, the financial institution 102 is located in the destination country.

That said, in connection with the fund transfer in this example, the mobile device 114, as configured by the application 116, solicits the details of the account to which the funds are to be transferred, such as, for example, an account credential, recipient's name, the amount of the transfer, and potentially, a selection of an account to fund the transfer, and other suitable data. The sender user 110 provides the solicited information to the mobile device 114, through manual entry of the data to an input device of the same. Specific to the account credential, in at least one embodiment, the mobile device 114, as configured by the application 116, may prompt the tap or insertion of a card device (or wallet device) of the receiver user 108 to acquire the account credential. In such an embodiment, in response to the prompt, the receiver user 108 taps the card device 109 on, or otherwise contactlessly interacts with, or inserts the card device 109 in the mobile device 114 of the sender user 110 (represented at dotted line A1), whereby the mobile device 114, as configured by the application 116, interacts with the card device 109 such that the card device 109 is configured to transmit the account credential, and potentially other data, to the mobile device 114.

It should be appreciated that the mobile device 114, as configured by the application 116, may rely on the data from the card device 109, via the interaction (e.g., contactless, etc.), or use that data from the card device 109 to retrieve additional information about the destination account and/or the receiver user 108. For example, the mobile device 114, as configured by the application 116, interacts with the processing network 106 to receive a name, address, etc., for the receiver user 108, or an account credential specific to the destination account based on data from the card device 109.

Additionally, or alternatively, the mobile device 114, as configured by the application 116, may be configured to retrieve the account credential. For example, the receiver user 108, instead of tapping/inserting the card device 109, enters a phone number, email address or other proxy specific to the destination account and/or the receiver user 108, whereby the mobile device 114, as configured by the application 116, looks up the proxy with the processing network 106, or another party (e.g., proxy directory computing device, etc., not shown) to retrieve the account credential for the funding account. In this way, the phone number, email address or other proxy may be included in a request for proxy resolution. More generally, again, FIG. 1 includes a number of filled circles (e.g., dots, etc.) at various parts of the system 100, any of which part may be involved with the mobile device 112 or the processing network 106, in the resolution of the proxy (e.g., as the proxy directory computing device, etc.) into an account number or other account data, as appropriate to the specific flow of data.

Thereafter, the mobile device 114, as configured by the application 116, submits a request for the fund transfer to the processing network 106, where the request includes the account credential from the card device 109 (or phone number, email address, or other proxy specific to the destination account and/or the receiver user 108, if applicable) and an account credential for the account (e.g., at the financial institution 104, etc.), which is the source of the fund transfer. The request also includes the amount of the transfer and any other data required for the transfer, and also any data elements required for a card-to-card, or P2P, transaction (as defined by the processing network 106, or service provided thereby).

Specifically, in this example embodiment, it should be appreciated that the mobile device 114, as configured by the application 116, submits the request, to the processing network 106, as an API call to a Send Funding API exposed by the processing network 106. In connection therewith, the mobile device 114, as configured by the application 116, performs a look-up of the acquiring credential of the financial institution 104, via the processing network 106 (and the database 108), as the funding institution for the fund transfer, and includes the acquiring credential in the request for the fund transfer.

In connection therewith, the processing network 106 is configured to compile and transmit an authorization request to the financial institution 104, where the request, in this embodiment, is consistent with the ISO 8583 (e.g., as a 0110 response, a 0210 response, etc.) (e.g., or potentially, the ISO 20022 standard, etc.). The authorization request includes the account credentials for the account issued by the financial institution 104 to the sender user 110 and the amount of the transaction, among other data, etc. In turn, the financial institution 104 is configured to compile a transaction reply, which, in this embodiment, is consistent with the ISO 8583 (e.g., as a 0110 response, a 0210 response, etc.) (e.g., or potentially, the ISO 20022 standard, etc.). The authorization reply indicates either approval or decline of the fund transfer. The financial institution 104 is configured to transmit the transaction reply back to the processing network 106, which is configured to pass the approval (or decline) to the mobile device 114.

Where the authorization reply indicates approval for the fund transfer, the mobile device 114, as configured by the application 116, submits the request, to the processing network 106, as an API call to a Send Payment API exposed by the processing network 106. In response, the processing network 106 is configured to initiate the fund transfer between the financial institution 104 and the intermediate financial institution 118 in the destination country, via a Send API, whereby the funds are transferred in near-real time to the intermediate financial institution 118. In turn, the intermediate financial institution 118 in the destination country is configured to initiate a real-time payment to the financial institution 102 in the destination country, based on the account credential for the account of the receiver user 108.

In a still further example, where the sender user 110 coordinates the transfer, the sender user 110 accesses the mobile application 116, at the mobile device 114, and indicates an instruction to transfer funds from the sender user 110 to the receiver user 108. In response, the mobile device 114, as configured by the application 116, solicits the name of the receiver user 108, the amount of the transfer, and potentially, a selection of an account to fund the transfer (i.e., a source account). The sender user 110 provides the solicited information to the mobile device 114. In turn, the mobile device 114, as configured by the application 116, prompts a contactless interaction with a card device (or wallet device) of the receiver user 108. For example, the mobile device 114, as configured by the application 116, solicits the card device (or wallet device) of the receiver user 108 be tapped on the mobile device 114, in general or at a specific location thereon. In this embodiment, in response to the prompt, the receiver user 108 retrieves the card device 109 and then taps the card device 109 on or otherwise contactlessly presents the card device 109 to the mobile device 114 of the sender user 110 (represented at dotted line A1*).

In turn, the mobile device 114, as configured by the application 116, interacts with the card device 109, whereupon the card device 109 is configured to transmit a credential, contactlessly, to the mobile device 114. In this example embodiment, the credential is a push-only credential, which is only usable to receive a transfer of funds to the account linked to the card device 109. It should be appreciated that the card device 109 may include multiple credentials, and is configured to provide the push-only credential in response to the interaction with the mobile device 114 (i.e., the mobile device 114 indicates to the card device 109 the fund transfer).

In connection therewith, the mobile device 114, as configured by the application 116, submits at least a name entered by the sender user 110 and the credential from the card device 109 to the institution 102 in order to confirm the name of the receiver user 108. In response, the financial institution 102 is configured to look up the account associated with the credential and to compare the name on the account to the name received from the mobile device 114. The financial institution 102 is further configured to provide a response to the mobile device 114, where the response includes an indication of match or mismatch of the name of the receiver user 108.

In addition, optionally, the mobile device 114, as configured by the application 116, submits the credential from the card device 109 to the P2P service provider 120 as part of a request to determine eligibility of the account linked to the credential for fund transfers. The P2P service provider 120 is configured to confirm to the mobile device 114 the eligibility (or ineligibility) of the account to receive funds. The eligibility of the account may be determined based on a type of the account, an issuer of the account (e.g., the financial institution 102, etc.), etc. For example, the financial institution 102 may designate a group of accounts (e.g., personal accounts, platinum accounts, etc.) as eligible for such transaction, and designate another group of accounts (e.g., business accounts, entry level accounts, etc.) as ineligible.

Based on the reply from the institution 102 indicating a name match, and potentially, the eligibility of the account (as determined by the P2P service provider 120), the mobile device 114, as configured by the application 116, submits a request for the fund transfer to the P2P service provider 120 (represented at dotted line A2*), where the request includes the credential from the card device 109 and a credential for the account (e.g., at the institution 104, etc.), which is the source of the fund transfer. The request also includes the amount of the transfer and any other data required for the transfer.

It should be appreciated that the eligibility inquiry may be integrated with the request for the fund transfer, whereby there is not dedicate request related to eligibility.

In connection therewith (and potentially after considering eligibility), the P2P service provider 120 is configured to compile and transmit an authorization request to the institution 104 (represented at dotted line A3*). The authorization request includes the credentials for the different accounts, the amount of the transfer, etc. In turn, the institution 104 is configured to compile a transaction request, which, in this embodiment, is consistent with the ISO 8385 standard. The financial institution 104 is configured to transmit the transaction request to the processing network 106, which is configured to transmit the transaction request to the institution 102. The institution 102 is configured to approve, or decline, the transaction request and to respond to the processing network 106 with a transaction response, which, in this embodiment, is also consistent with the ISO 8385 standard.

The processing network 106 is configured to pass the transaction response to the institution 104, which is configured to pass the transaction response to the P2P service provider 120.

The P2P service provider 120 is configured to provide a transfer notification, indicating whether the transfer is approved or declined, to the communication device 114. In connection therewith, the institution 102 is further configured to transmit a notification to the receiver user 108, which indicates the transfer is approved or declined.

It should be appreciated that various fund transfer schemes may be employed from the P2P service provider 120, consistent with the ISO 8385 standard, the ISO 20022 standard, or other standard, etc.

In another example, where the receiver user 108 coordinates the transfer, the receiver user 108 accesses the mobile application 116 and indicates an instruction to transfer funds from the sender user 110 to the receiver user 108. In response, the mobile device 112, as configured by the application 116, solicits the name of the sender user 110, the amount of the transfer, and a selection of an account into which the funds are to be received. The receiver user 108 provides the solicited information to the mobile device 112. In this embodiment, the account selected is the account issued to the receiver user 108 by the institution 102 (i.e., recipient account).

In turn, the mobile device 112, as configured by application 116, prompts a contactless interaction with a card device (or wallet device) linked to the account funding transfer (e.g., the card device 111, etc.). For example, the mobile device 114, as configured by the application 116, solicits the card device (or wallet device) of the receiver user 108 be tapped on the mobile device 114, in general or at a specific location thereon. In this embodiment, in response to the prompt, the sender user 110 retrieves the card device 111 and then taps the card device 111 on or otherwise contactlessly presents the card device 111 to the mobile device 112 of the receiver user 108 (represented at dotted line B1*). The mobile device 112, as configured by the application 116, interacts with the card device 111, whereupon the card device 111 is configured to transmit a credential to the mobile device 112. In this example embodiment, the credential is a pull-only credential, which is only usable to send a transfer of funds from the account linked to the card device 111. It should be appreciated that the card device 111 may include multiple credentials, and is configured to provide the pull-only credential, or general credential (i.e., enabled for push and pull interactions) in response to the interaction with the mobile device 112.

In connection therewith, the mobile device 112, as configured by the application 116, optionally submits the credential from the card device 111 to the P2P service provider 120. Consistent with the above, the P2P service provider 120 is configured to determine the eligibility of the account linked to the credential from the card device 111, and to indicate the eligibility (or ineligibility) of the account to be a source of the fund transfer based on the credential. Again, eligibility of the account may be determined based on a type of the account, an issuer of the account (e.g., the financial institution 104, etc.), etc. For example, the financial institution 104 may designate a group of accounts (e.g., personal accounts, platinum accounts, etc.) as eligible for such transaction, and designate another group of accounts (e.g., business accounts, entry level accounts, etc.) as ineligible.

It should be appreciated that eligibility may be determined after the request for the fund transfer, and not as a prior separate operation in other embodiments.

Based on the eligibility of the account (or unknown eligibility), the mobile device 112, as configured by the application 116, submits a request for the fund transfer to the P2P service provider 120 (represented at dotted line B2*). The P2P service provider 120, in turn, is configured to proceed as described above to (determine eligibility, if required to do so and not completed yet and) facilitate the fund transfer between the account of the sender user 110 and the account of the receiver user 108, by submitting an authorization request to the institution 102 (represented at dotted line B3*) (whereby the above-described authorization operations again occur, this time initiated from the institution 102, through the processing network 106, to the institution 104, and back).

Again, it should be appreciated that various fund transfer schemes may be employed from the P2P service provider 120, consistent with the ISO 8385 standard, the ISO 20022 standard, or other standard, etc.

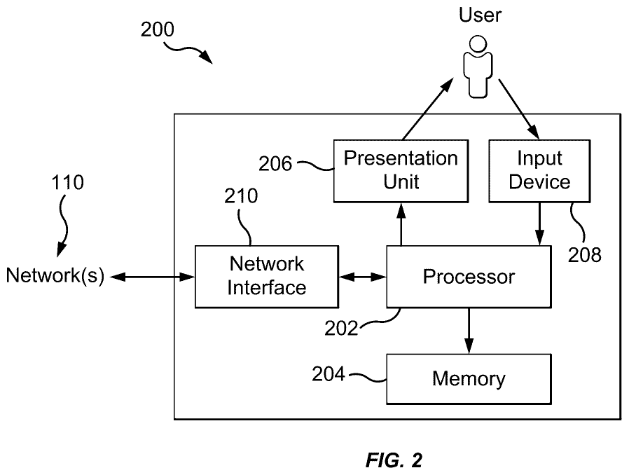

FIG. 2 illustrates an example computing device 200 that can be used in the system 100. The computing device 200 may include, for example, one or more servers, workstations, personal computers, POS terminals, laptops, tablets, smartphones, etc. In addition, the computing device 200 may include a single computing device, or it may include multiple computing devices located in close proximity or distributed over a geographic region as a network of computing devices, so long as the computing devices are specifically configured to function as described herein. In particular, in the example system 100 of FIG. 1, each of the financial institutions 102 and 104, the processing network 106, and the intermediate financial institution 118 should be understood as being implemented in (and/or otherwise including) one or more computing devices consistent with the computing device 200. In addition, the mobile devices 112 and 114 are also consistent with computing device 200. That said, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, account credentials, and/or other types of data (and/or data structures) suitable for use as described herein. Furthermore, in various embodiments, executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein and, in various examples, transforms the computing device 200 into a special-purpose computing device specifically configured in accordance with (and to achieve) the description(s) herein. It should be appreciated that the memory 204 may include a variety of different memories, each implemented in one or more of the functions or processes described herein.

In addition, in the example embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., a notification for fund transfers, etc.), either visually or audibly, to a user of the computing device 200, for example, to one or the users 108 and 110 in the system 100, to users associated with other parts of the system 100, etc. And various interfaces (e.g., as defined by applications, webpages, etc.) may be displayed at the computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user of the device (i.e., user inputs) such as, for example, names of users, amounts to be transferred, etc. The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device (e.g., the mobile devices 112 and 114, etc.), may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a ZigBee adapter, an RFID adapter, a Bluetooth adapter, etc.), a global position system (GPS) adapter, a mobile network adapter, or other device capable of communicating to/with one or more different networks, including one or more of the networks in FIG. 1. Further, in some example embodiments, the computing device 200 may include the processor 202 and one or more network interfaces (including the network interface 210) incorporated into or with the processor 202.

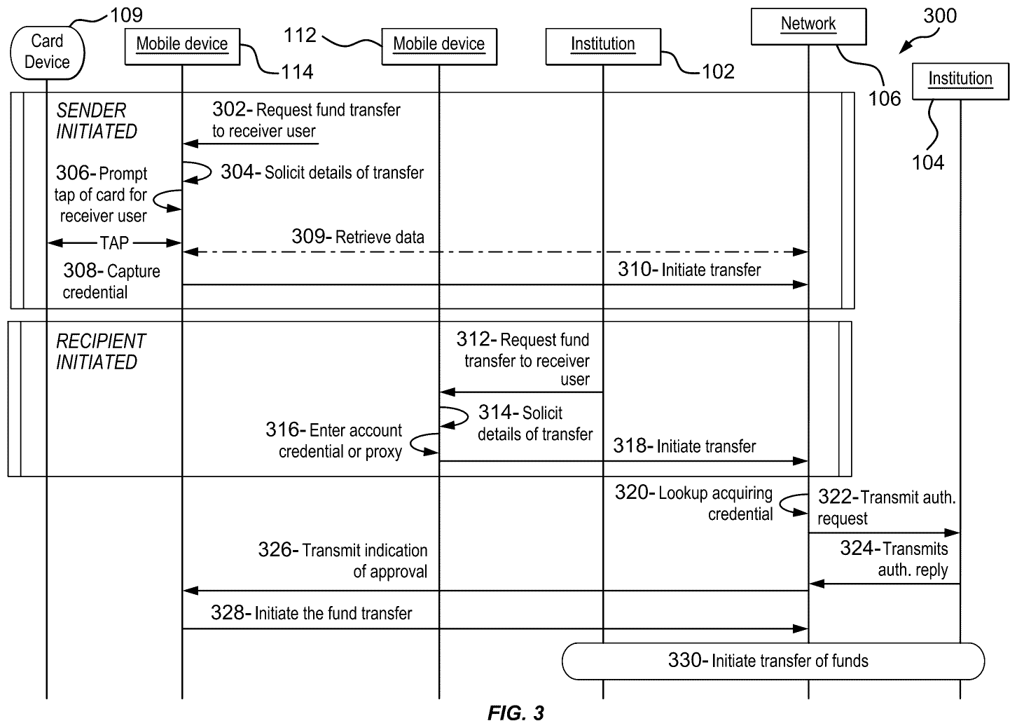

FIG. 3 illustrates an example method 300 for use in facilitating an enhanced network transaction between a sender user and a receiver user. The example method 300 is described with reference to the mobile device 112 (and the application 116 therein), the mobile device 114 (and the application therein), and the processing network 106, as well as other aspects of the system 100, and also to the computing device 200. However, it should be understood that the method 300 is not limited to the system 100 or the computing device 200. And, likewise, the systems and the computing devices herein should not be understood to be limited to the example method 300.

At the outset, it should be appreciated that, in this example, the network transaction is a fund transfer, which may be initiated by the sender user 110 or the receiver user 108, and whereby both operations are illustrated in FIG. 3.

Initially, as shown, for a sender-initiated transaction, at 302, the sender user 110 requests a fund transfer to the receiver user 108, via the mobile device 114. In particular, the sender user 110 accesses the application 116, at the mobile device 114, and selects an option for a fund transfer. In response, the mobile device 114 solicits, at 304, details of the fund transfer, including, for example, a name of the receiver user 108, an amount of the transfer, a source account of the fund transfer (e.g., in the absence of a default, etc.), a notation or note which is descriptive of the fund transfer (e.g., reason, etc.), etc. Specifically, as it relates to the source account (where there is a default account, or not), the mobile device 114 may prompt the sender user 110 to select one of the accounts registered to the application 116, or to enter an account not previously registered or provisioned to the application 116, etc. It should be appreciated that the mobile device 114 may solicit any details of the fund transfer, the receiver user 108, or the sender user 110 in connection with the fund transfer, etc. In turn, the sender user 110 enters the details of the fund transfer to the mobile device 114, via an input device thereof (e.g., manual entry to the input device 208, etc.). In this example, the sender user 110 selects/enters the source account, which is issued by the institution 104.

At 306, in this example, the mobile device 114 prompts a tap of the card device 109 on the mobile device 114, by the receiver user 108 or by the sender user 110. In response, the receiver user 108, in this example, taps, at 308, the card device 109 on the mobile device 114. In connection with the tap (broadly, contactless interaction), the mobile device 114 retrieves and/or receives (broadly, captures), at 308, a credential for an account linked to the card device 109 and issued to the receiver user 108 (by the institution 102, in this example). It should be appreciated that additional information may be received from, or retrieved from, the card device 109 to support the fund transfer (e.g., as permitted by contactless payment standards, etc.) in connection with the interaction between the card device 109 and the mobile device 114. Further, optionally, as indicated by the dotted line, the mobile device 114 may retrieve, at 309, additional data from the processing network 106, based on the data received/retrieved from the card device 109. For example, the mobile device 114 may retrieve a name, address, etc., for the receiver user 108, from the processing network 106, based on the account credential received/retrieved from the card device 109. In this way, manual entry of certain data may be omitted.

Additionally, or alternatively, it should be appreciated that the account of the receiver user 108 may be otherwise identified to the mobile device 114. For example, either user 108 or user 110 may enter an account number, or a proxy specific to the account issued by the institution 104, as a credential, either manually or automatically (e.g., scan a computer-readable indicia, etc.).

Upon receiving the credential, the mobile device 114 initiates, at 310, through the processing network 106, the fund transfer from the account of the sender user 110 issued by the institution 104 to the account of the receiver user 108 issued by the institution 102. In particular, in this embodiment, the mobile device 114 submits the request, to the processing network 106, as an API call, for example, to a Send Funding API, etc.

Alternatively, for a receiver-initiated transaction, at 312, the receiver user 108 requests, at 312, a fund transfer from the sender user 110, via the mobile device 112. In particular, the receiver user 108 accesses the application 116, at the mobile device 112, and selects an option for a fund transfer. In response, the mobile device 112 solicits, at 314, details of the fund transfer, including, for example, a name of the receiver user 108 and/or the sender user 110, an account of the sender user 110 (i.e., source account, etc.), an amount of the transfer, a destination account of the fund transfer, a notation or note which is descriptive of the fund transfer (e.g., reason, etc.), etc.

In turn, at 316, in this example, the receiver user 108 and/or the sender user 110 enters into the mobile device 112 the requested information, including, for example, an account credential for the destination account, which, again, may include an account number or proxy specific to the account (e.g., email address, phone number, etc.). The receiver user 108 and/or the sender user 110 further enters (e.g., manually at an input device, etc.) the other solicited details of the fund transfer. Upon receipt of the solicited details of the transfer, mobile device 112 initiates, at 318, through the processing network 106, the fund transfer from the account of the sender user 110 issued by the institution 104 to the account of the receiver user 108 issued by the institution 102. In particular, as above, in this embodiment, the mobile device 114 submits the request, to the processing network 106, as an application programming interface (API) call, for example, to the Send Funding API, etc. exposed by the processing network 106.

In response, regardless of which user initiated the fund transfer, the processing network 106 performs a lookup, at 320, for the acquiring credential for the financial institution 104, as the source account for the fund transfer.

In turn, the processing network 106 transmits an authorization request for transaction (e.g., compiles the authorization request based on the lookup, etc.) to the institution 104, at 322, where the authorization request includes the details of the fund transfer. In response, the financial institution 104 determines whether to approve or decline the fund transfer of the authorization request. For example, the financial institution 102 may confirm that the fund transfer is directed towards the account issued by the institution 104, and that said account includes sufficient funds. In this example, the financial institution 104 determines to approve the fund transfer, whereupon the institution 104 compiles an authorization reply, which, again, may be based on the financial interchange messaging standard (e.g., as a 0110 response, a 0210 response, etc.) or otherwise. The financial institution 104 transmits, at 324, the transaction response to the processing network 106, which transmits, at 326, an indication of approval to the mobile device 114.

Based on the indication of approval, the mobile device 114 submits, at 328, a fund transfer instruction, to initiate the fund transfer, to the processing network 106, as an API call, for example, to a Send Payment API, etc. In response, the processing network 106 initiates, at 330, the fund transfer between the financial institution 102 and the financial institution 104, via, for example, a Send API, whereby the funds are transferred in near-real time. That is, the financial institution 102 posts funds to the receiver user's account and the financial institution 104 debits funds to the sender user's account.

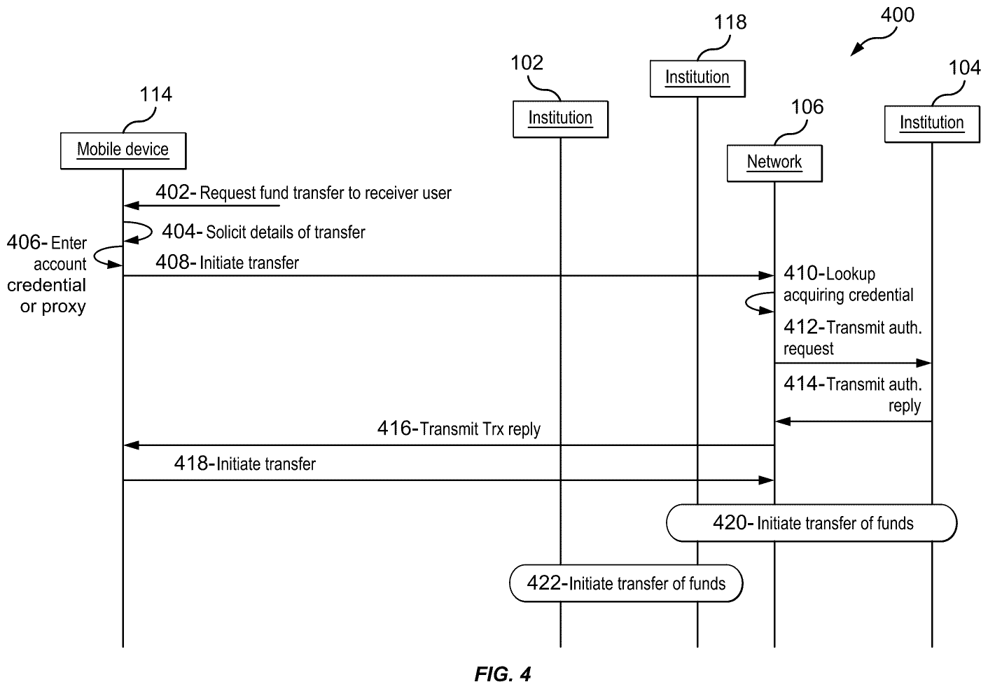

FIG. 4 illustrates an example method 400 for use in facilitating an enhanced network transaction (or interaction) between a sender user and a receiver user, which includes a cross-border transfer. The example method 400 is described with reference to the mobile device 114 (and the application 116 therein), and the processing network 106, as well as other aspects of the system 100, and also to the computing device 200. However, it should be understood that the method 400 is not limited to the system 100 or the computing device 200. And, likewise, the systems and the computing devices herein should not be understood to be limited to the example method 400.

At the outset, it should be appreciated that, in this example, the network transaction is a fund transfer, which may be initiated by the sender user 110 in connection with the method 400, as shown.

Initially, as shown, at 402, the sender user 110 requests a fund transfer to the receiver user 108, via the mobile device 114. In particular, the sender user 110 accesses the application 116, at the mobile device 112, and selects an option for a fund transfer. In response, the mobile device 114 solicits, at 404, details of the fund transfer, including, for example, a name of the receiver user 108 and/or the sender user 110, an account of the sender user 110 (i.e., source account, etc.), an amount of the transfer, a destination account of the fund transfer, a notation or note which is descriptive of the fund transfer (e.g., reason, etc.), etc.

In turn, at 406, in this example, the sender user 110 and/or the receiver user 108 enters into the mobile device 114, the requested information, including, for example, an account credential for the destination account, which, again, may include an account number or proxy specific to the account (e.g., email address, phone number, etc.), and potentially, a country of origin of the destination account, i.e., a destination country. The sender user 110 and/or the receiver user 108 further enters (e.g., manually at an input device, etc.) the other solicited details of the fund transfer. Upon receipt of the solicited details of the transfer, mobile device 114 initiates, at 408, through the processing network 106, the fund transfer from the account of the sender user 110 issued by the institution 104 to the account of the receiver user 108 issued by the institution 102. In particular, as above, in this embodiment, the mobile device 114 submits the request, to the processing network 106, as an API call to a Send Funding API exposed by the processing network 106.

In response, the processing network 106 performs a lookup, at 410, for the acquiring credential for the financial institution 104, as the source account for the fund transfer.

In turn, the processing network 106 transmits an authorization request for the transaction (e.g., compiles the authorization request based on the lookup, etc.) to the financial institution 104 (i.e., the funding institution), at 412, where the authorization request includes the details of the fund transfer. In response, the financial institution 104 determines whether to approve or decline the fund transfer of the authorization request. For example, the financial institution 104 may confirm that the fund transfer is directed towards the account issued by the institution 104, and that said account includes sufficient funds. In this example, the financial institution 104 determines to approve the fund transfer, whereupon the institution 104 compiles an authorization reply, which, again, may be based on the financial interchange messaging standard (e.g., as a 0110 response, a 0210 response, etc.) or otherwise. The financial institution 104 transmits, at 414, the authorization reply to the processing network 106, which transmits, at 416, an indication of the approval to the mobile device 114 (e.g., as a transaction reply, etc.).

Based on the indication of approval, the mobile device 114 submits, at 418, a fund transfer instruction, to initiate the transfer, to the processing network 106, as an API call to a Send Payment API. In response, the processing network 106 initiates, at 420, the fund transfer between the financial institution 104 and the intermediate financial institution 118, located in the destination country, via a Send API, whereby the funds are transferred in near-real time. That is, the financial institution 104 posts funds to the receiver user's account and the financial institution 104 debits funds to the sender user's account. Next, as shown, the intermediate financial institution 118 in the destination country initiates, at 422, a real time fund transfer of the received funds to the financial institution 102 in the destination country, which, in turn, posts the funds to the account of the receiver user 108.

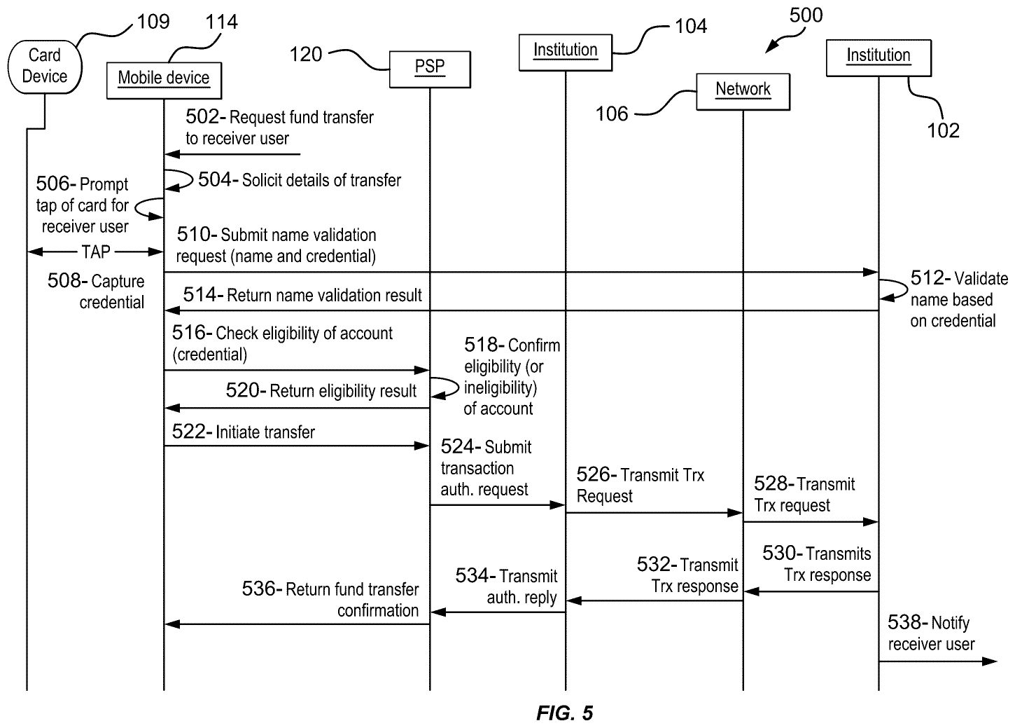

FIG. 5 illustrates an example method 500 for use in facilitating a contactless-initiated network transaction between a sender user and a receiver user. The example method 500 is described with reference to the mobile device 112 (and the application 116 therein), the mobile device 114 (and the application therein), and the P2P service provider 120, as well as other aspects of the system 100, and also to the computing device 200. However, it should be understood that the method 500 is not limited to the system 100 or the computing device 200. And, likewise, the systems and the computing devices herein should not be understood to be limited to the example method 500.

Initially in the method 500, it should be understood (as described above) that each of the users 108 and 110 have the virtual wallet application 116 installed and active in their mobile devices 112 and 114, respectively. In addition, each of the users 108 and 110 has also been issued an account, which is linked to their respective card device 109, 111, which, in turn, is enabled for contactless communication.

At 502, the sender user 110 requests a fund transfer to the receiver user 108, via the mobile device 114. In particular, the sender user 110 accesses the application 116, at the mobile device 114, and selects an option for a fund transfer. In response, the mobile device 114 solicits, at 504, details of the fund transfer, including, for example, a name of the receiver user 108, an amount of the transfer, a source account of the fund transfer, a notation or note which is descriptive of the fund transfer (e.g., reason, etc.), etc. Specifically, as a relates to the source account, the mobile device 114 may prompt the sender user 110 to select one of the accounts registered or provisioned to the application 116, or to enter an account not previously registered or provisioned to the application 116, etc. It should be appreciated that the mobile device 114 may solicit any details of the fund transfer, the receiver user 108, or the sender user 110 in connection with the fund transfer, etc. In turn, the sender user 110 enters the details of the fund transfer to the mobile device 114, via an input device thereof (e.g., the input device 208, etc.). In this example, the sender user 110 selects or enters the source account, which is issued by the institution 104.

The mobile device 114 captures the details of the fund transfer and assigns a transfer ID to the details.

At 506, in this example, the mobile device 114 prompts a tap of the card device 109 on the mobile device 114, by the receiver user 108 or by the sender user 110.

In response, the receiver user 108, in this example, taps, at 508, the card device 109 on the mobile device 114. In connection with the tap (broadly, contactless interaction), the mobile device 114 retrieves and/or receives a credential for an account linked to the card device 109 and issued to the receiver user 108 (by the institution 102, in this example). In particular, in connection with the tap, the mobile device 114 indicates the fund transfer to the card device 109, whereupon the card device 109 identifies a deposit-only or push-only credential specific to the account. That is, the credential only permits inbound funds to the account, whereby outbound or debit transactions with the credential are declined. In this example, as noted, the account identified by the credential is the account issued to the receiver user 108 by the institution 102.

It should be appreciated that additional information may be received from, or retrieved from, the card device 109 to support the fund transfer (e.g., as permitted by contactless payment standards, etc.)

Upon receiving the credential, the mobile device 114 submits, at 510, the name of the receiver user 108 and the credential to the institution 102, as a name validation request.

In response, the institution 102 validates, at 512, the name based on the credential. That is, the institution 102 accesses the account based on the credential and compares the name associated with the account with the name received in the name validation request from the mobile device 114. When there is a match (or close match (e.g., abbreviation (e.g., Michael versus Mike, etc.), etc.)), the name validation is successful. When there is no match, the name validation is failed.

At 514, the institution 102 returns a name validation result, which indicates the successful or failed validation of the name.

At the same time as the name validation, or prior to, or after, the mobile device 114 checks the eligibility of the account for the fund transfer with the P2P service provider 120, at 516. The eligibility check includes the credential received from the card device 109. Upon receipt of the eligibility check, the P2P service provider 120 confirms the eligibility or ineligibility of the account for fund transfers. In one or more embodiments, eligibility of the account is determined based on data that the P2P service provider 120 is able to obtain from the institution 104 (e.g., as the acquirer, etc.) or card data that is provisioned at the time of card issuance. The institution 104 is permitted, in turn, to obtain card credential eligibility via the processing network 106, for example, which may provide card range tables, etc. If card data that is provisioned has an eligibility flag, then the P2P service provider 120 is permitted to read the flag following (or after or in response to, etc.) the contactless interaction (e.g., tap, etc.) or following the account/card digitization process, for example, to make the appropriate determination. At 520, the P2P service provider 120 returns an eligibility result, which indicates the eligibility or ineligibility of the account for the fund transfer.

It should be appreciated that, despite the illustration in FIG. 5 of the name validation being prior to the eligibility check, these steps may occur in the opposite order, or at the same time in other method embodiments. It should also be appreciated that in one or more embodiments, the name validation and/or eligibility check may be omitted.

With continued reference to FIG. 5, based on a successful name validation and a confirmed eligibility of the account for fund transfers, the mobile device 114 initiates, at 522, the fund transfer from the account of the sender user 110 issued by the institution 104 to the account of the receiver user 108 issued by the institution 102. In connection therewith, the mobile device 114 provides the fund transfer details to the P2P service provider 120, where the details include, without limitation, the credential for the account of the receiver user 108 received from the card device 109, a credential for the source account (as entered by the sender user 110), the amount of the fund transfer (as entered by the sender user 110), etc.

In response, the P2P service provider 120 submits, at 524, a transaction authorization request to the institution 104, as the acquirer institution for the fund transfer. In turn, the institution 104 compiles a transaction request (i.e., Trx request), which is consistent with a financial interchange messaging standard, such as for example, the ISO 8585 standard, ISO 20022 standard, etc. (e.g., a 0100 message, a 0200 message, etc.) or other communication scheme (e.g., an API, etc.), etc., and transmits, at 526, the transaction request to the processing network 106.

The processing network 106 transmits the transaction request to the institution 102, at 528. In response, the institution 102 determines whether to approve or decline the fund transfer of the transaction request. For example, the institution 102 may confirm that the fund transfer is directed towards the account issued by the institution 102 given the credential for the account in the transfer request is a push-only credential. In this example, the institution 102 determines to approve the fund transfer, whereupon the institution 102 compiles a transaction response (i.e., Trx response), which, again, may be based on the financial interchange messaging standard (e.g., as a 0110 response, a 0210 response, etc.) or otherwise. The institution 102 transmits, at 550, the transaction response to the processing network 106.

The processing network 106 transmits the transaction response to the institution 104, at 552. In turn, the institution 104 transmits, at 554, an authorization reply to the P2P service provider 120.

The P2P service provider 120 returns, at 556, a fund transfer confirmation to the mobile device 114, which indicates to the sender user 110 that the fund transfer has been completed. Similarly, at 558, the institution 102 notifies the receiver user 108 of the fund transfer being completed (e.g., via the mobile device 112, etc.) (e.g., via the application 116, email, SMS, etc.), etc.

While the method 500 includes the fund transfer being initiated by the sender user 110, via the mobile device 114 and the contactless communication of the card device 109 with the mobile device 114, it should be appreciated that a fund transfer may be similarly initiated by the receiver user 108, via the mobile device 112 and a contactless communication of the card device 111 with the mobile device 112, whereby the mobile device 112 performs similar to the mobile device 114 in FIG. 5. In such an example, the card device 111 may provide a pull-only credential, which only permits outbound or debit transfers from the account issued by the institution 104 to the sender user 110.

It should also be appreciated that while the sender user 110 and the receiver user 108 are apparently different users in method 500, the sender user and the receiver user may be the same user, whereby that user is transferring funds from one account to another (i.e., both accounts being issued to that user, etc.).

In view of the above, the systems and methods herein rely on contactless communication between a card device and a mobile device to initiate a fund transfer from a sender user to a receiver user, with limited interaction with the user presenting the card device for contactless communication. In this way the technical aspects of the description herein enable efficient communication of information pertinent to the fund transfer, thereby limiting the friction involved in the fund transfer.

The card devices (e.g., card devices 109, 111, etc.) herein may include, in general, a payment card (e.g., plastic card, etc.), which complies with, in various embodiment, the ISO/IEC 7810 ID-1 standard, which generally indicates the particular physical dimensions and/or dimensional proportions of the card device (i.e., which is the payment card in this instance) (e.g., a first dimension (either length or width) of about 85.60 mm (about 5.57 inches) and a second dimension (the other of length or width) of about 55.98 mm (about 2.15 inches), and a thickness dimension of about 0.76 mm (about 0.05 inches); etc.). Of course, however, other card device embodiments may be constructed according to one or more different standards (e.g., ISO/IEC 7810 ID-2, ISO/IEC 7810 ID-5, ISO/IEC 7810 ID-000, etc.). That said, in one or more embodiments, card devices herein may have (without limitation) dimensions (lengths and/or widths) ranging between about 15 mm (about 0.59 inches) and about 150 mm (about 5.91 inches), and thicknesses ranging from about 0.1 mm (about 0.004 inches) to about 1 mm (about 0.04 inches).

It should be appreciated that the card device may be implemented in another form factor in example embodiments (e.g., in a form factor other than a card device, etc.), including, specifically, a passive device such as, for example, a fob (e.g., a key fob, etc.), a tag, a sticker, etc.

What's more, the card device (or devices having other form factors) may be considered to be consistent with a NFC form factor, whereby the card device (or other device) is a passive (and contactless) target device, which is powered and “read” by another device (e.g., mobile devices, 112, 114, etc.). In connection therewith, NFC is a set of short-range wireless technologies, typically requiring a separation of about 10 cm or less between the card device (e.g., the card device 109, 111, etc.) and the mobile device 112, 114, in this example. It should be understood that NFC operates, for example, at about 15.56 MHz on ISO/IEC 18000-5 air interface and at rates ranging from about 106 kbit/s to about 424 kbit/s.

In view of the above, the systems and methods herein provide for contactless fund transfers, between accounts, where credentials (e.g., push only credentials, pull only credentials, etc.) are shared, through contactless interactions with card devices (e.g., via taps, etc.), between sender users and receiver users to initiate the fund transfers. For example, when a receiver user's card device is tapped or otherwise contactlessly interfaced to a mobile device of the sender user, the necessary information from the card device and the sender user is used to verify the fund transfer and then to execute the push fund transfer to the account specific to the receiver's card device. In this way, contactless technology of the card device is leveraged to initiate the fund transfer, in a manner not previously available. As such, a technical solution is provided for fund transfers.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

The card devices (e.g., card devices 109, 111, etc.) herein may include, in general, a payment card (e.g., plastic card, etc.), which complies with, in various embodiment, the ISO/IEC 7810 ID-1 standard, which generally indicates the particular physical dimensions and/or dimensional proportions of the card device (i.e., which is the payment card in this instance) (e.g., a first dimension (either length or width) of about 85.60 mm (about 3.37 inches) and a second dimension (the other of length or width) of about 53.98 mm (about 2.13 inches), and a thickness dimension of about 0.76 mm (about 0.03 inches); etc.). Of course, however, other card device embodiments may be constructed according to one or more different standards (e.g., ISO/IEC 7810 ID-2, ISO/IEC 7810 ID-3, ISO/IEC 7810 ID-000, etc.). That said, in one or more embodiments, card devices herein may have (without limitation) dimensions (lengths and/or widths) ranging between about 15 mm (about 0.59 inches) and about 150 mm (about 5.91 inches), and thicknesses ranging from about 0.1 mm (about 0.004 inches) to about 1 mm (about 0.04 inches).

It should be appreciated that the card device may be implemented in another form factor in example embodiments (e.g., in a form factor other than a card device, etc.), including, specifically, a passive device such as, for example, a fob (e.g., a key fob, etc.), a tag, a sticker, etc.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims, including: (a) receiving, by a processing network, a request for a fund transfer from a mobile device, in lieu of a request from a financial institution, the fund transfer between a source account and a destination account, the mobile device associated with one of a sender user and a receiver user, the request including an amount of the fund transfer and a credential associated with the destination account; (b) identifying, by the processing network, an acquiring credential of a financial institution that issued the source account; (c) transmitting, by the processing network, an authorization request for the fund transfer to the financial institution, whereby the financial institution approves the fund transfer; and/or (d) based on the approval from the financial institution, initiating the fund transfer between the source account and the destination account.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims, including: (a) soliciting details of a push person-to-person (P2P) fund transfer, the details including a name of a receiver user and an amount of the push P2P fund transfer; (b) receiving the details of the push P2P fund transfer; (c) prompting a contactless device for the receiver user to be presented at the smartphone mobile device, whereby one of the sender user and the receiver user presents the contactless device of the receiver user to the smartphone mobile device; (d) in response to the contactless device being presented, contactlessly capturing a credential specific to a receiver account from the contactless device of the receiver user; (e) validating, with an issuer of the receiver account, the name of the receiver user included in the details of the push P2P fund transfer; and/or (f) in response to the name being valid, initiating, through a payment service provider (PSP) computing device, a request for the push P2P fund transfer from a source account to the receiver account based on the credential.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and “at least one of” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in enhanced network transactions, the method comprising:
receiving, by a processing network, a request for a fund transfer from a mobile device, in lieu of a request from a financial institution, the fund transfer between a source account and a destination account, the mobile device associated with one of a sender user and a receiver user, the request including an amount of the fund transfer and a credential associated with the destination account;
identifying, by the processing network, an acquiring credential of a financial institution that issued the source account;
transmitting, by the processing network, an authorization request for the fund transfer to the financial institution, whereby the financial institution approves the fund transfer; and
based on the approval from the financial institution, initiating the fund transfer between the source account and the destination account.

2. The computer-implemented method of claim 1, wherein the financial institution is an issuer of the source account to the sender user.

3. The computer-implemented method of claim 2, further comprising:
transmitting an approval from the financial institution to the mobile device; and
receiving a fund transfer instruction, in response to the approval, from the mobile device; and
wherein initiating the fund transfer includes initiating the fund transfer in response to the fund transfer instruction.

4. The computer-implemented method of claim 1, wherein the credential associated with the destination account includes a proxy; and
further comprising resolving, by the processing network, the proxy into an account number, prior to initiating the fund transfer.

5. The computer-implemented method of claim 1, wherein the destination account is issued by a financial institution in a foreign country; and
wherein initiating the fund transfer includes initiating the fund transfer from the source account to an intermediate financial institution in the foreign country, whereby the intermediate financial institution initiates the fund transfer to the destination account.

6. A system for use in enhanced network transactions, the system comprising a processing network computing device configured to:
receive a request for a fund transfer from a mobile device, in lieu of a request from a financial institution, the fund transfer between a source account and a destination account, the mobile device associated with one of a sender user and a receiver user, the request including an amount of the fund transfer and a credential associated with the destination account;
identify an acquiring credential of a financial institution that issued the source account;
transmit an authorization request for the fund transfer to the financial institution, whereby the financial institution approves the fund transfer; and
based on the approval from the financial institution, initiate the fund transfer between the source account and the destination account.

7. The system of claim 6, wherein the financial institution is an issuer of the source account to the sender user.

8. The system of claim 6, wherein the credential associated with the destination account includes a proxy; and
wherein the processing network computing device is further configured to resolve the proxy into an account number, prior to transmitting the authorization request for the fund transfer to the financial institution.

9. The computer-implemented method of claim 6, wherein the destination account is issued by a financial institution in a foreign country; and
wherein the processing network computing device is configured, in order to initiate the fund transfer, to initiate the fund transfer from the source account to an intermediate financial institution in the foreign country, whereby the intermediate financial institution initiates the fund transfer to the destination account.

10. A computer-implemented method for use in facilitating a contactless network transaction, the method comprising:
soliciting, by a smartphone mobile device specific to a sender user, details of a push person-to-person (P2P) fund transfer, the details including a name of a receiver user and an amount of the push P2P fund transfer;
receiving, at the smartphone mobile device, the details of the push P2P fund transfer;
prompting, by the smartphone mobile device, a contactless device for the receiver user to be presented at the smartphone mobile device, whereby one of the sender user and the receiver user presents the contactless device of the receiver user to the smartphone mobile device;
in response to the contactless device being presented at the smartphone mobile device, contactlessly capturing, by the smartphone mobile device, a credential specific to a receiver account from the contactless device of the receiver user;
validating, by the smartphone mobile device, with an issuer of the receiver account, the name of the receiver user included in the details of the push P2P fund transfer; and
in response to the name being valid, initiating, by the mobile device, through a payment service provider (PSP) computing device, a request for the push P2P fund transfer from a source account to the receiver account based on the credential.

11. The computer-implemented method of claim 10, wherein receiving the details of the push P2P fund transfer includes receiving, at an input device of the smartphone mobile device, manual entry at a key pad entry of the name and the amount.

12. The computer-implemented method of claim 10, wherein the credential from the contactless device of the receiver user includes a deposit only credential for the receiver account, the credential including an account number.

13. The computer-implemented method of claim 10, further comprising soliciting and receiving, by the smartphone mobile device, a selection of a source account of the sender user for the push P2P fund transfer; and
wherein the request for the push P2P fund transfer includes an account number specific to the source account.

14. The computer-implemented method of claim 10, further comprising:
compiling and transmitting, by the PSP computing device, an authorization request specific to the push P2P fund transfer to a financial institution, which issued the sender account;
reviving, by the PSP computing device, an authorization reply from the financial institution; and
returning, by the PSP computing device, a confirmation of the push P2P fund transfer being complete.

15. The computer-implemented method of claim 10, further comprising determining, by the smartphone mobile device, eligibility of the receiver account to receive the push P2P fund transfer; and
wherein initiating the fund transfer is further in response to determining the receiver account is eligible for the push P2P fund transfer.

16. The computer-implemented method of claim 10, wherein the contactless device is a contactless card device.

17. The computer-implemented method of claim 16, wherein the contactless card device is a plastic, passive NFC-enabled card device, consistent with the ISO/IEC 7810 standard.

18. The computer-implemented method of claim 10, wherein the contactless device is a NFC-enabled fob, tag, or sticker.
